(19) United States
(12) Patent Application Publication
(10) Pub. No.: US 2016/0104578 A1
(43) Pub. Date: Apr. 14, 2016

(54) MULTI-LAYER CERAMIC CAPACITOR

(71) Applicant: SAMSUNG ELECTRO-MECHANICS CO., LTD., Suwon-Si (KR)

(72) Inventors: Bum Suk KANG, Suwon-Si (KR); Su Jin LEE, Busan-Si (KR); Hew Young KIM, Suwon-Si (KR); Hee Sang KANG, Paju-si (KR); Woo Sup KIM, Anyang-si (KR); Seong Min CHIN, Suwon-Si (KR)

(21) Appl. No.: 14/878,868

(22) Filed: Oct. 8, 2015

(30) Foreign Application Priority Data
Oct. 10, 2014 (KR) 10-2014-0136752

(51) Int. Cl. H01G 4/248; H01G 4/012; H01G 4/12; H01G 4/30

(52) U.S. Cl. CPC H01G 4/248; H01G 4/30; H01G 4/012; H01G 4/12

(57) ABSTRACT

The present invention relates to a multi-layer ceramic capacitor which includes a ceramic main body formed by stacking internal electrodes and dielectric layers alternately and an external electrode formed by stacking a coating layer and a plating layer on both ends of the ceramic main body sequentially, wherein the coating layer includes conductive metal powder and a(Si, B)-b(Li, K)-c(Ba, Ca)-d(Mn, V, Zn)-e(Ti, Sn, Zr, Al) component of glass frit (herein, 20≦a≦60, 10≦b≦35, 2≦c≦30, 2≦d≦20 and 0.5≦e≦30 mol %, a+b+c+d=100 mol %).

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2014-0136752, entitled filed Oct. 10, 2014, which is hereby incorporated by reference in its entirety into this application.”

### BACKGROUND OF THE INVENTION

1. Field of the Invention

The present invention relates to an electronic component embedded printed circuit board, and more particularly, to a method for manufacturing an electronic component embedded printed circuit board that can improve bonding reliability of an embedded electronic component.

2. Description of the Related Art

In general, an electronic component using a ceramic material such as a capacitor, an inductor, a piezoelectric device includes a ceramic main body formed a ceramic material, an internal terminal formed inside of a ceramic body and an external terminal installed on a surface of the ceramic body to be connected with the internal electrode.

A multi-layer ceramic capacitor (MLCC) among the ceramic electronic components includes a plurality of ceramic dielectric sheets, an internal electrode inserted between the plurality of ceramic dielectric sheets and an external electrode electrically connected to the internal electrode.

Although such multi-layer ceramic capacitor is compact, but it can realize a high electrostatic capacitance and may be easily mounted on a substrate to thereby widely use as a capacitive element in various electronic devices.

### RELATED ART DOCUMENT

### Patent Document

Patent Document 1: Korean Patent Laid-open Publication No. 10-2005-0048855

### SUMMARY OF THE INVENTION

An object of the present invention to provide a multi-layer ceramic capacitor capable of improving the reliability of chip by intensifying the corrosion-resistant of an external electrode to an alkaline plating solution.

In accordance with one aspect of the present invention to achieve the object, there is provided a multi-layer ceramic capacitor capable of preventing an alkaline plating solution from being penetrated into an internal electrode during a plating process for forming a plating layer for the external electrode in the multi-layer ceramic capacitor having the external electrode with a relatively small thickness since a nickel plating layer is omitted.

This can be achieved by supplying the external electrode to include a glass frit having an excellent corrosion-resistant to the alkaline plating solution.

At this time, the glass frit has a composition of a(Si, B)-b(Li, K)-c(Ba, Ca)-d(Mn, V, Zn)-e(Ti, Sn, Zr, Al)(herein, 20≦a≦60, 10≦b≦35, 2≦c≦30, 2≦d≦20 and 0.5≦e≦30 mol %, a+b+c+d=100 mol %), a corrosion-resistant to an alkaline plating solution is improved by adding at least one among Ti, Sn, Zr and Al.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view of a multi-layer ceramic capacitor in accordance with an embodiment of the present invention;

FIG. 2 is a cross-sectional view cut along a line I-I′ of FIG. 1;

FIG. 3 is a partial exploded perspective view of a ceramic sheet used in stacking a ceramic main body of FIG. 1;

FIG. 4 is a graph representing an alkali resistance evaluation result of the multi-layer ceramic capacitor in accordance with embodiment examples 1˜8 and comparison examples 1˜5 of the present invention; and

FIG. 5 is a graph showing a HALT pass rate of the multi-layer ceramic capacitor in accordance with the embodiment examples 1˜8 and the comparison examples 1˜5 of the present invention.

### DETAILED DESCRIPTION OF THE PREFERABLE EMBODIMENTS

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

The objects, specific advantages, and novel features of the present invention will become more apparent from the following detailed description and preferable embodiments when taken in conjunction with the accompanying drawings. In the specification, in adding reference numerals to elements of each drawing, it is to be noted that like reference numerals like elements even through elements are shown in different drawings. Further, in describing the present invention, a detailed description of related well-know techniques will be omitted so as not to obscure the subject of the present invention. In the specification, the terms “first”, “second”, and so on are used to distinguish between similar elements and do not limit the elements.

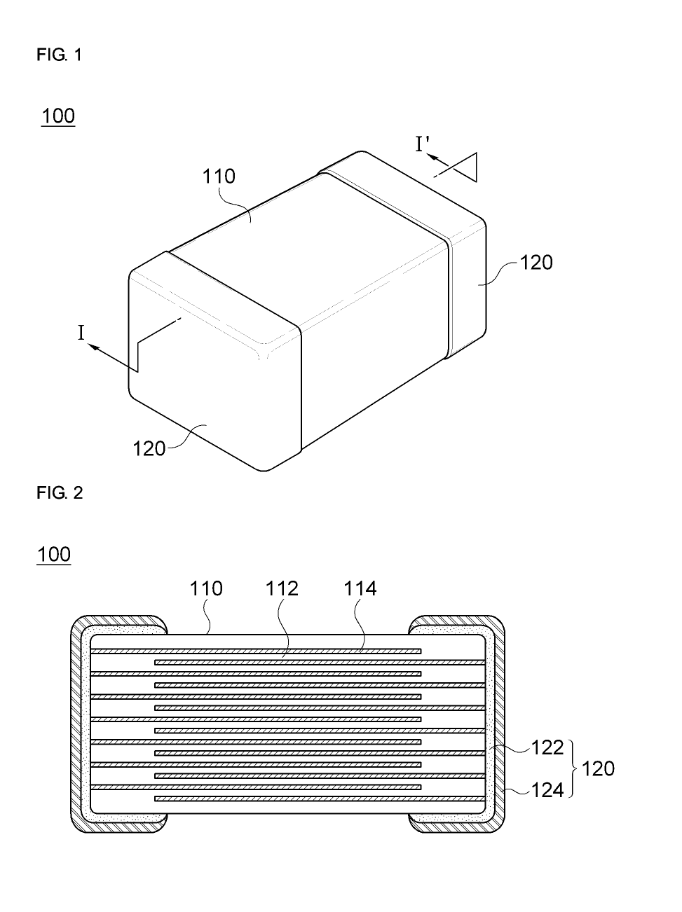

Hereinafter, referring to FIG. 1 to FIG. 5, a multi-layer ceramic capacitor in accordance with the present invention will be described in detail.

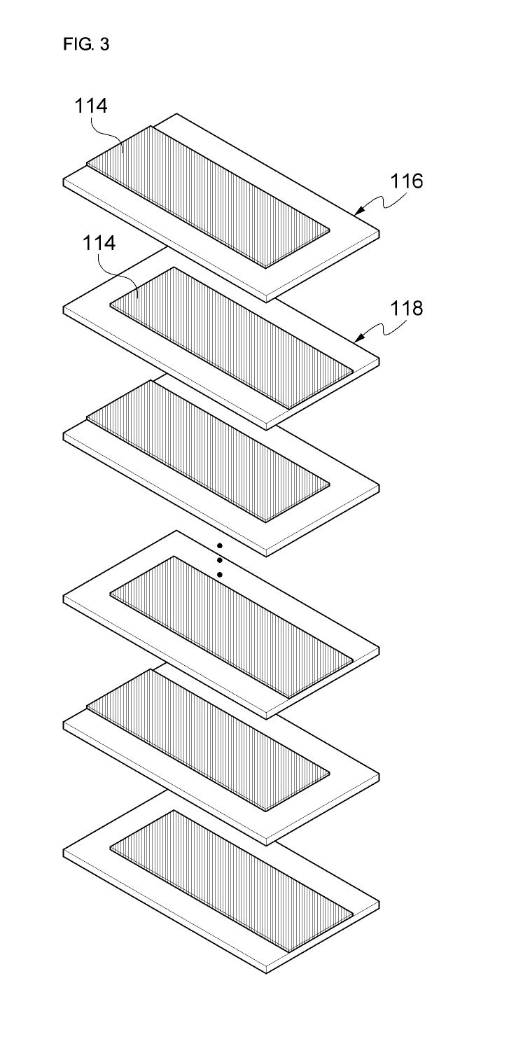

FIG. 1 is a perspective view of a multi-layer ceramic capacitor in accordance with an embodiment of the present invention, FIG. 2 is a cross-sectional view cut along a line I-I′ of FIG. 1 and FIG. 3 is a partial exploded perspective view of a ceramic sheet used in stacking a ceramic main body of FIG. 1.

Referring to FIG. 1 and FIG. 2, the multi-layer ceramic capacitor 100 in accordance with the embodiment of the present invention includes a ceramic main body 110 and external electrodes 120 formed both end portions of the ceramic main body 110.

The ceramic main body 110 is formed by stacking a plurality of dielectric layers 112 therein and inserting inner electrodes 114 between the plurality of dielectric layers 112.

At this time, the dielectric layer 112 is a ceramic dielectric layer made of ceramic, and it is a ceramic dielectric sheet manufactured in a sheet of a plate-shape.

The ceramic main body 110, for example, after a plurality of ceramic green sheets constituting of a ferroelectric material such as barium titanate is stacked and compressed, is finished as a housing type through a sintering process, the gaps between adjacent ceramic sheets are integrated to a degree that the boundary thereof is indistinguishable. Accordingly, even on the drawings is shown integrally without distinguishing each of the ceramic sheets.

As shown in FIG. 2, anodes and cathodes of internal electrodes 114 may be alternately arranged by inserting a plurality of dielectric layers 112 therebetween.

In this case, as shown in FIG. 3, after the first ceramic sheets 116 formed therein the internal electrodes 114 to expose one ends thereof to the outside and the second ceramic sheets 118 formed therein the internal electrodes 114 to the other ends opposite to one ends to the outside are alternately stacked and sintered, the ceramic main body 110 of FIG. 2 may be formed.

That is, the ceramic main body 110 may be formed by stacking a plurality of ceramic sheets printed thereon the internal electrodes 114 to differentiate the direction of interlayer exposed ends.

Such internal electrode 114 may be formed of a conductive material, e.g., at least one metal selected from a group consisting of Ni, Pd, Al, Fe, Cu, Ti, Cr, Au, Ag, Pt or the alloy thereof.

The internal electrode 114 may be formed of a conductive paste, e.g., a metal thin film sintered through a sintering process after coated with a metal paste, on one surface of the ceramic sheet.

Once more, referring to FIG. 1 and FIG. 2, the external electrodes 120 are formed on both ends of the ceramic main body 110.

The external electrode 120 can play a role of an external terminal to electrically connect the internal electrodes 114 and the external device by being connected to the inner electrode 114, in which the ends thereof are exposed to the outside of the ceramic main body 110.

One of the pair of external electrodes 120 is connected to the internal electrode 114 in which one end is exposed to the outside of the ceramic main body 110, and the other is connected to the internal electrode 114 in which the other end is exposed to the outside of the ceramic main body 110.

For example, the internal electrode 114 connected to the external electrode 120 formed on one side of the ceramic main body 110 may be a cathode, and the internal electrode 114 connected to the external electrode 120 formed on the other side of the ceramic main body 110 may be an anode.

The external electrode 120 in accordance with the embodiment of the present invention is constituted of a coating layer 122 and a plating layer 124.

At this time, the coating layer 122 is formed on the surfaces of both ends of the ceramic main body 110, and includes a conductive metal powder and a glass frit.

For example, the conductive metal powder may be a copper without being limited if it can be used for manufacturing the external electrode.

The multi-layer ceramic capacitor is generally formed of a plating layer such as Sn or Cu on the most outer layer of the external electrode for improving the solderbility.

However, while the thickness of the external electrode becomes thinner in order for the compactness and the large capacity of the multi-layer ceramic capacitor, after sintering the external electrodes, there occurs the problems of chip reliability deteriorations due to the penetration of plating solution into the electrodes during the plating process.

This is caused since the glass in the external electrodes has corrosion resistance not excellent to the plating solution and the glass is eroded by the plating solution to whereby the plating solution penetrates into the electrodes.

In general, although the glass has the basic corrosion resistance to the water as neutral pH, acid solution (pH<7) and alkali solution (pH>7), according to passing the contact time to the solution, the glass component is flown out as the solvent through the process such as the reaction formula 1.

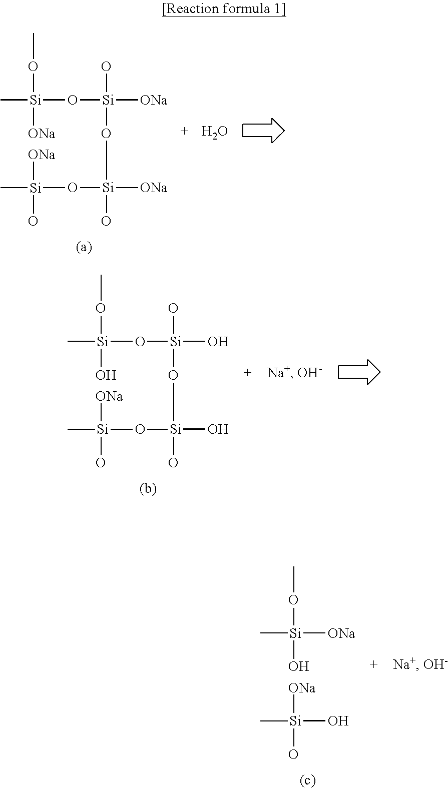

At first, in the step (a) of the condition that t=0 and pH=7 without the contact time (t) with the solution, as reaching to the step (b) of the condition that t>0 and pH<9 wherein the t is the contact time with the solution, the selective elution of the alkali ions occurs at the surface of the glass, thereby forming the Si—OH layer.

And, if reaching the step (c) of the condition that pH>9 by increasing the concentration of OH in the solution due to the elution of the alkali ions while the contact time is further longer with the solution in the step (b) to thereby t>>0, the surface layer of the glass is delaminated by collapsing and eluding the whole surface layer of the glass having the large Si—OH since the Si—O—Si resolution due to the OH occurs and the selective elution of the alkali ions occurs at the newly exposed surface.

Accordingly, in order to solve the problems that the alkali plating solution is penetrated into the electrode and the reliability of the chip is deteriorated due to this, in accordance with the present invention, there is provided an external electrode including a glass frit having an excellent corrosion resistance to the alkali plating solution.

The glass applied to the external electrode has the composition mixed with various oxides, in accordance with the present embodiment, in order to intensify the corrosion resistance to the alkali plating solution of the glass, the type or the composition ratio of the oxides contained in the glass is controlled as below.

Glass Frit

The glass frit in accordance with the glass frit has the composition of a(Si, B)-b(Li, K)-c(Ba, Ca)-d(Mn, V, Zn)-e(Ti, Sn, Zn, Al), herein the mole percent (mol %) becomes a+b+c+d=100 in the mole percent (mol %) range of 20≦a≦60, 10≦b≦35, 2≦c≦30, 2≦d≦20 and 0.5≦e≦30.

Hereinafter, the roles and the contents of each component including into the glass frit in accordance with the embodiment of the present invention will be described.

Si, B

In the present embodiment, the Si and B play a role of a network former as an element to form cross-linking oxygen by making the skeleton of glass.

It is preferable that the content (a) of Si and/or B is ranging from 20 mol % to 60 mol % of the total content of the glass frit.

At this time, the content (a) is less than 20 mol %, the devitrification may be generated. Whereas if the content (a) exceeds 60 mol %, the melting point becomes too high and the liquid phase cannot be realized in the electrode sintering temperature interval.

Li, K

In the embodiment of the present invention, the Li and the K play a role of reducing the melting point of the glass by forming the nonbridging oxygen as an alkali component as R₂O.

It is preferable that the content (b) of Li and/or K is ranging from 10 mol % to 35 mol % of the total content of the glass frit.

At this time, the content (b) is less than 10 mol %, the melting point becomes too high and the liquid phase cannot be implemented in the electrode sintering temperature interval. Whereas if the content (b) exceeds 35 mol %, the corrosion resistance may become weak for the acid or alkali plating solution.

Ba, Ca

In the present embodiment, the Ba and Ca play roles of sintering at a low temperature and improving the density when the external electrode is sintered as the component of RO.

It is preferable that the content (c) of Ba and/or Ca is ranging from 2 mol % to 30 mol % of the total content of the glass frit.

At this time, the content (c) is less than 2 mol %, the nonplastic property of Cu may be generated in the electrode sintering temperature interval. Whereas if the content (c) exceeds 30 mol %, the corrosion resistance may become weak for the acid or the alkali plating solution.

Mn, V, Zn

In the present embodiment, the Mn, V and Zn are the component of determining the flow of the liquid in the region where the glass forms the liquid phase and have an improved liquidities as their contents are increased.

It is preferable that at least one of content (d) selected from Mn, V and Zn is ranging from 2 mol % to 20 mol % of the total content of the glass frit.

At this time, the content (d) is less than 2 mol %, the agglomeration of glass may be generated by decreasing the liquidity of liquid phase in the temperature interval completely destroyed by fire. Whereas if the content (d) exceeds 20 mol %, the nonplastic property may be generated due to the moving distance increment between Cu powders because the liquidity of the liquid phase is too high.

Ti, Sn, Zr, Al

In the present embodiment, the Ti, Sn, Zr and Al play roles of improving the corrosion resistance for the alkali solution.

Although the hydroxide is formed, the TiO₂ is not flown out as an ion form, since the activity of the oxide or the hydroxide is larger than that of the ion in a large pH region and the energy barrier for elution is high. Accordingly, in accordance with the embodiment of the present invention, it is preferred that the Ti is used in the aspect that the corrosion resistance is improved for the alkali solution. And also, the addition of Ti is advantageous in the aspect of the electrode sintering temperature on the characteristics of the glass to be applied to the paste for the external electrode.

Meanwhile, Sn, Zr and Al assign the corrosion resistance to the alkali solution by the mechanism similar to Ti.

It is preferable that at least one of the content (e) selected from Ti, Sn, Zr and Al is ranging from 0.5 mol % to 30 mol % of the total content of the glass frit, and it is further preferable that the content (e) is ranging from 3 mol % to 10 mol %.

At this time, if the content (e) is less than 0.5 mol %, the corrosion resistance cannot be implemented for the alkali plating solution. Whereas, if the content (e) exceeds 30 mol %, the liquid phase cannot be implemented in the electrode sintering temperature interval since the melting temperature becomes too high.

The average particle size (D50 criteria) of the glass frit is the conductive metal powder, specifically, it can be controlled to an appropriate size for obtaining the effect of intensifying the corrosion resistance for the plating solution with the wettability excellent to Cu, for example, it may be ranged from 0.1 μm to 3.0 μm.

At this time, if the glass frit has an average particle size of 0.1 μm or less, it is difficult to acquire as the shape of dry grinding. Whereas, if the glass frit has an average particle size exceeds 3.0 μm, the failure may be generated due to the difficult implement of the corner coverage due to the coarse particle.

And also, the content of the glass frit may be ranged from 1 wt % to 20 wt % in comparison with the conductive metal powder.

At this time, if the content of the glass frit is less than 1 wt % in comparison with the conductive metal powder, the effect of improving the corrosion resistance is insufficient for the Cu plating solution, and it is difficult to implement the low temperature sintering of the external electrode. Whereas, if the content of the glass frit exceeds 20 wt % in comparison with the conductive metal powder, the adverse effect is caused to the density implementation of the external electrode by the side effect generation of the nonplastic property generation due to the moving distance increment between Cu powders rather than the effect for improving the corrosion resistance to the Cu plating solution.

And also, the density of the glass frit may be ranged from 1.5 g/cc to 5 g/cc. If the intensity of the glass frit is less than 1.5 g/cc, the beading to float from the surface after finishing the external electrode sintering can be generated. Whereas, if the density of the glass frit exceeds 5 g/cc, the contact between the internal electrode and the external electrode can be prevented since the excessive amount of glass is placed at the interface between the external electrode and the ceramic.

The coating layer 122 of the external electrode 120 of such construction can intensify the corrosion resistance to the alkali plating solution by including the glass frit obtained by adding at least one group selected from Ti, Sn, Zr and Al.

One example of the manufacturing process of the glass frit having the composition in accordance with the embodiment of the present invention is as follows.

At first, after the oxide is composed as the composition ratio of a(Si, B)-b(Li, K)-c(Ba, Ca)-d(Mn, V, Zn)-e(Ti, Sn, Zr, Al), wherein the mol % satisfies that 20≦a≦60, 10≦b≦35, 2≦c≦30, 2≦d≦20, 0.5≦e≦30 and a+b+c+d=100, the raw materials are mixed. Thereafter, the glass fused material is formed by heating the mixed raw materials to the temperature ranging from 1,000° C. to 1,300° C. And then, after the glass fused material is rapidly cooled through a roller, the glass state material is to be frit in the power shape having the average particle size ranging from 0.1 μm to 3.0 μm by being grinded using a jet mill.

The coating layer 122 constituting of the external electrode 120 in accordance with the embodiment of the present invention may be formed by coating the paste on both ends of the ceramic body 110, after the above composed glass frit and the conductive metal powder are dispersed on a vehicle to be formed in a paste. At this time, the organic vehicle may be an organic binder to give the liquid phase characteristics to the paste composition, and may further include the organic solvent.

The organic binder can be used by mixing one group or at least two groups of the cellulosic polymers except the acrylic polymer.

The organic solvent plays roles of solving the organic binder and controlling the viscosity of the paste, and a well known material, e.g., glycol ether, can be used without limiting thereto if it is compatibility to the organic binder.

The plating layer 124 among the layers constituting the external electrode 120 is formed by a process of plating on the coating layer 122.

For example, the plating layer 124 may be formed with copper (Cu) as a layer to improve the solderbility when the multi-layer ceramic capacitor 100 is mounted on the circuit board.

The plating layer 124 may be formed through a sintering process at a temperature ranging from 700° C. to 900° C., after the copper is plated on the surface of the coating layer 122 by dipping the ceramic body 110, on which the coating layer 122 is formed, in the alkali copper plating solution.

The multi-layer ceramic capacitor 100 may improve the reliability of chips by preventing the alkali plating solution from penetrating into the inner electrode 114 even in case that the thickness of the external electrode 120 is thin in accordance with the embodiment of the present invention, by forming the external electrode 120 by including the coating layer 122 having the glass frit which reinforces the corrosion resistance to the alkali plating solution by adding Ti, Sn, Zr, Al or the like.

Accordingly, the multi-layer ceramic capacitor 100 improves the reliability of embedded type capacitor which performs the copper plating without forming the nickel plating layer as well as can achieve the compactness and the high capacitance of the multi-layer ceramic capacitor.

### EMBODIMENT

Hereinafter, the constructions and functions of the present invention will be further described in detail through a preferred embodiment of the present invention. Merely, it is suggested as a preferred example of the present invention, but cannot be interpreted as limiting the present invention by any means.

Since the contents not described herein can be sufficiently derived technically by the person ordinarily skilled in the art, the explanations thereof will be omitted.

1. Manufacture of a Sample

The samples of the ceramic capacitor are manufactured under the condition described in the table 1 according to the embodiments 1˜8 and the comparison examples 1˜5.

### Embodiments 1˜8

After the 10 wt % glass frit with the average particle size of 2.5 μm and the 70 wt % Cu powder with the average particle size of 1.0 μm are mixed with the 15 wt % organic binder and the 5 wt % organic solvent, the paste is manufactured by spreading the 3 roll with 8 passes. Thereafter, after the paste is coated on the ceramic body, it is sintered during 1 hour in the oven maintaining the temperature of 780° C.

At this time, the glass frit is used, wherein the composition ratio of the glass frit satisfies that a(Si, B)-b(Li, K)-c(Ba, Ca)-d(Mn, V, Zn)-e(Ti, Sn, Zr, Al), wherein the mol % satisfies that 20≦a≦60, 10≦b≦35, 2≦c≦30, 2≦d≦20, 0.5≦e≦30 and a+b+c+d=100, and the composition of e(Ti, Sn, Zr, Al) and the composition of a(Si, B)-b(Li, K)-c(Ba, Ca)-d(Mn, V, Zn) to form the remaining reaction layer are as shown in each embodiment.

### Comparison Example 1

The remaining parts are performed similar to the embodiments 1˜8 except that the glass frit without adding e(Ti, Sn, Zr, Al) is used.

### Comparison Examples 2˜5

The remaining parts are performed similar to the embodiments 1˜8 except that the glass frit to add e(Ti, Sn, Zr, Al) with 0.1 mol %, 0.3 mol %, 32 mol %, 35 mol %, respectively, is used.

TABLE 1

| | Glass content | Additive contents |
|---|---|---|
| classification | to form reaction layer | of e(Ti, Sn, Zr, Al) |
| Comparison example 1 | 100 mol % | — |
| Comparison example 2 | 99.9 mol % | 0.1 mol % |
| Comparison example 3 | 99.7 mol % | 0.3 mol % |
| Embodiment 1 | 99.5 mol % | 0.5 mol % |
| Embodiment 2 | 99.0 mol % | 1.0 mol % |
| Embodiment 3 | 97.0 mol % | 3.0 mol % |
| Embodiment 4 | 95.0 mol % | 5.0 mol % |
| Embodiment 5 | 90.0 mol % | 10.0 mol % |
| Embodiment 6 | 85.0 mol % | 15.0 mol % |
| Embodiment 7 | 80.0 mol % | 20.0 mol % |
| Embodiment 8 | 70.0 mol % | 30.0 mol % |
| Comparison example 4 | 68.0 mol % | 32.0 mol % |
| Comparison example 5 | 65.0 mol % | 35.0 mol % |

2. Evaluation of Physical Property

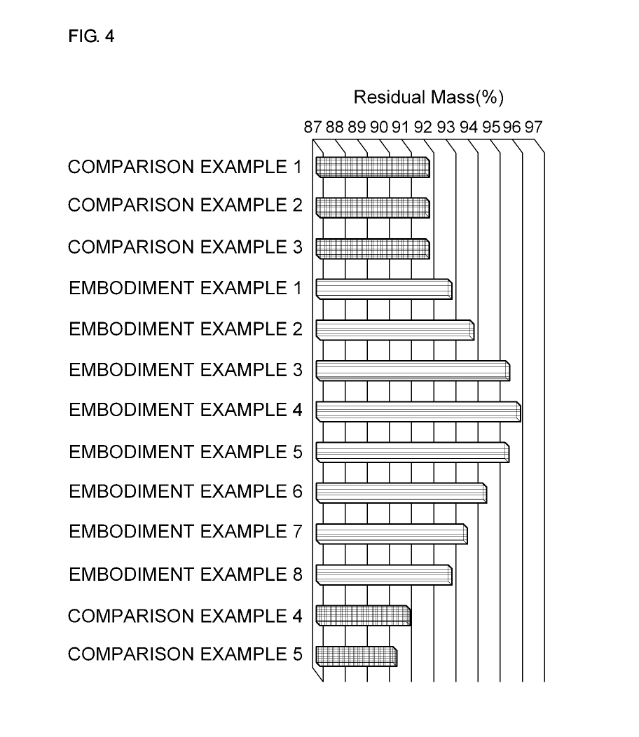

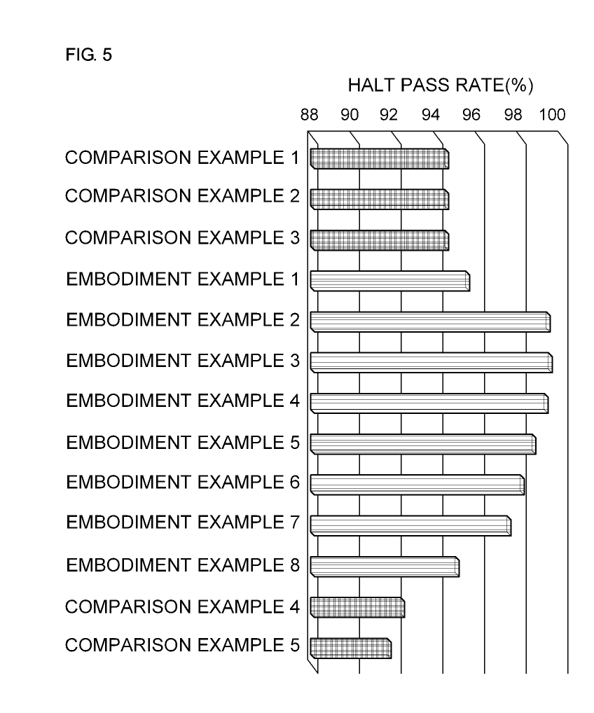

The alkali resistance and the high accelerated life test (HALT) of the samples are evaluated in accordance with the embodiments 1˜8 and the comparison examples 1˜5 and these results are represented in FIG. 4 and FIG. 5, respectively.

Each evaluation method is as follows.

<Alkali Resistance>

After each sample is deposited during 12 hours in the copper plating solution having pH=8.5 in accordance with the embodiment of 1˜8 and the comparison examples 1˜5, the corrosion resistance is evaluated through the measurement of the mass loss amount due to the glass elution after cleaning and drying it.

<Pass Rate of HALT>

The high temperature acceleration lifetime is evaluated by maintaining the direct current of 2Vr (12.6V) as the application state at the temperature of 130° C., for each sample in accordance with the embodiments 1˜8 and the comparison examples 1˜5 and measuring the degree of deterioration of the insulating resistor. At this time, the degree of deterioration is identified by evaluating 50 numbers of samples during 6 hours.

FIG. 4 is a graph representing an alkali resistance evaluation result of the multi-layer ceramic capacitor in accordance with embodiment examples 1˜8 and comparison examples 1˜5 of the present invention and FIG. 5 is a graph showing a HALT pass rate of the multi-layer ceramic capacitor in accordance with the embodiment examples 1˜8 and the comparison examples 1˜5 of the present invention.

Referring to FIG. 4, in case of the embodiments 1˜8 to satisfy the glass composition range of the present invention, it can be identified that the corrosion resistance to the alkali plating solution is excellent since the remaining amount rate of the glass is high in comparison with the comparison examples 1˜5. That is, in case of the embodiments 1˜8, it can be identified that the corrosion resistance to the alkali plating solution is excellent since the loss rate of the glass is low in comparison with the comparison examples 1˜5.

Particularly, in the embodiments 3˜5, the remaining rate of the glass increases about 4% in comparison with the comparison examples 1˜3, according to increasing at the degree of about 5% in comparison with the comparison example 5, it can be understood that the corrosion resistance to the alkali plating solution is drastically excellent in comparison with the comparison examples.

On the other hands, if the components of e(Ti, Sn, Zr, Al) are added into the glass exceeding 30 mol % as like the comparison examples 4 and 5, the alkali resistance becomes weak by the excessive amount of TiO₂, SnO₂, ZrO₂, Al2O₃ or the like is precipitated as the crystal in the inside of the amorphous glass.

Referring to FIG. 5, the HLAT passing rate represents the trend similar to the alkali resistance evaluation result of FIG. 4, in this results, it can be understood that the alkali resistance and the HLAT have a very intimate relationship.

That is, in case of the embodiments 1˜8 to satisfy the glass composition range of the present invention, it can be identified that the corrosion resistance as well as the high temperature acceleration lifetime is improved in comparison with the comparison examples 1˜5.

The multi-layer ceramic capacitor in accordance with the present invention may improve the reliability of chip by preventing the plating solution from penetrating into the inner electrode even in case that the thickness of the external electrode is thin, by forming the external electrode including the glass frit that the corrosion resistance to the alkali plating solution is reinforced.

The foregoing description illustrates the present invention. Additionally, the foregoing description shows and explains only the preferred embodiments of the present invention, but it is to be understood that the present invention is capable of use in various other combinations, modifications, and environments and is capable of changes and modifications within the scope of the inventive concept as expressed herein, commensurate with the above teachings and/or the skill or knowledge of the related art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

What is claimed is:

1. A multi-layer ceramic capacitor comprising:
a ceramic main body formed by stacking internal electrodes and dielectric layers alternately; and
an external electrode formed by stacking a coating layer and a plating layer on both ends of the ceramic main body sequentially;
wherein the coating layer includes conductive metal powder and a(Si, B)-b(Li, K)-c(Ba, Ca)-d(Mn, V, Zn)-e(Ti, Sn, Zr, Al) component of glass frit (herein, 20≦a≦60, 10≦b≦35, 2≦c≦30, 2≦d≦20 and 0.5≦e≦30 mol %, a+b+c+d=100 mol %).

2. The multi-layer ceramic capacitor according to claim 1, wherein the conductive metal powder is copper (Cu).

3. The multi-layer ceramic capacitor according to claim 1, wherein a content of the glass frit is ranging from 1 wt % to 20 wt % in comparison with the conductive metal powder.

4. The multi-layer ceramic capacitor according to claim 1, wherein the plating layer is copper.

5. The multi-layer ceramic capacitor according to claim 1, wherein an average particle size of the glass frit is ranging from 0.1 μm to 3.0 μm.

6. The multi-layer ceramic capacitor according to claim 1, wherein an density of the glass frit is ranging from 1.5 g/cc to 5 g/cc.

7. The multi-layer ceramic capacitor according to claim 1, wherein the glass frit has a corrosion-resistant to an alkaline plating solution.
